(19) United States
(12) Patent Application Publication
(10) Pub. No.: US 2026/0018630 A1
(43) Pub. Date: Jan. 15, 2026

(54) MEMBRANE STACK AND AIR HUMIDIFIER

(71) Applicant: MAHLE International GmbH, Stuttgart (DE)

(72) Inventors: Sven Alexander Kaiser, Waiblingen (DE); Peter Nowak, Stuttgart (DE); Tobias Baumgart, Winterbach (DE); Bernd Dressler, Stuttgart (DE); Samuel Kohler, Weil im Schoenbuch (DE)

(21) Appl. No.: 19/263,412

(22) Filed: Jul. 8, 2025

(30) Foreign Application Priority Data
Jul. 9, 2024 (DE) 102024119466.9

(51) Int. Cl. H01M 8/04119

(52) U.S. Cl. CPC H01M 8/04149

(57) ABSTRACT

A membrane stack for an air humidifier of a fuel cell for humidifying a dry supply air flow of the fuel cell via a humid exhaust air flow of the fuel cell may include a plurality of membranes and a plurality of spacers. The membranes may be permeable to humidity and impermeable to air. The membranes may be arranged one above another in a stacking direction such that at least a subset of the membranes each separate a respective supply air path of a plurality of supply air paths, which each connect a supply air inlet to a supply air outlet, from a respective exhaust air path of a plurality of exhaust air paths, which each connect an exhaust air inlet to an exhaust air outlet. The spacers may each be arranged in the stacking direction between two directly adjacent membranes and in one of the exhaust air paths.

### CROSS-REFERENCE TO RELATED APPLICATIONS

This application claims priority to German Patent Application No. DE 102024119466.9, filed on Jul. 9, 2024, the contents of which is hereby incorporated by reference in its entirety.

### TECHNICAL FIELD

The present invention relates to a membrane stack for an air humidifier of a fuel cell for humidifying a dry supply air flow of the fuel cell by means of a humid exhaust air flow of the fuel cell.

### BACKGROUND

DE 10 2021 204 247 A1 discloses an air humidifier with a membrane stack of the known type, wherein the membrane stack is configured in a cuboid shape, has a stacking direction and four stacking sides transverse to the stacking direction. The membrane stack also has a vertical direction parallel to the stacking direction, a longitudinal direction perpendicular to the vertical direction, and a transverse direction perpendicular to both the vertical direction and the longitudinal direction. The four stacking sides form a supply air inlet and a supply air outlet, which are turned away from each other and/or spaced apart in the longitudinal direction, as well as an exhaust air inlet and an exhaust air outlet, which are turned away from each other and/or spaced apart in the transverse direction. The membrane stack has several membranes which are permeable to humidity, i.e., to water and/or water vapor, and impermeable to air, and which are arranged one above the other in the stacking direction in such a way that the membranes within the membrane stack each separate a supply air path, which connects the supply air inlet to the supply air outlet, from an exhaust air path, which connects the exhaust air inlet to the exhaust air outlet.

For efficient humidification, relatively thin membranes can be used, which are arranged close together in the stacking direction to ensure a compact design of the air humidifier. In this process, membranes can lie against each other in the stacking direction. For example, when the air humidifier is in operation, the pressure in the supply air flow may be higher than in the exhaust air flow. This presses the membranes in the supply air paths outwards against the exhaust air paths, reducing the cross-sectional area available for air flow in the exhaust air paths and increasing the flow resistance for the exhaust air flow. This may impair the function of the air humidifier.

### SUMMARY

The present invention addresses the problem of providing an improved or at least different design for a membrane stack of the type described above or for an air humidifier equipped with it, which is characterized in particular by improved functional reliability and/or low flow resistance when air flows through the membrane stack along the supply air paths and/or along the exhaust air paths.

The invention solves this problem with the scope of the independent claim(s). Advantageous embodiments are the subject-matter of the dependent claim(s).

The invention is based on the general idea of equipping the membrane stack with spacers which keep two directly adjacent membranes, which delimit an exhaust air path, at a distance within this exhaust air path. This prevents the membranes in the exhaust air paths from coming into contact with each other in the event of excess pressure in the supply air paths. This maintains or ensures a predetermined flowable cross-section for the exhaust air paths, whereby the membrane stack according to the invention is characterized by low flow resistance.

Specifically, it is proposed that the membrane stack has several spacers, which are arranged in the stacking direction between two directly adjacent membranes in one of the exhaust air paths. This means that each spacer is assigned two membranes that are in contact with the spacer and an exhaust air path that is delimited by the two membranes in the stacking direction. As a result, the two membranes adjacent to the respective spacer in this exhaust air path are spaced apart from each other in the stacking direction by the spacer. The exhaust air path assigned to the spacer is the exhaust air path that is delimited by the two membranes in the stacking direction, which are adjacent to the spacer or are kept at a distance from the spacer.

The spacers are made of a different material than the membranes. For example, they can be made from a relatively stable plastic and therefore have relatively high dimensional stability. In any case, the spacers are significantly more dimensionally stable than the thin membranes.

In one embodiment, the respective spacer between the exhaust air inlet and the exhaust air outlet may be tapered in the vertical direction, in particular with a reduction in thickness.

Preferably, the respective taper of two spacers immediately following one another in the stacking direction forms the respective supply air path and/or delimits it.

In other words, the reduction in size of two spacers directly following one another in the stacking direction allows the flow to pass through the membrane stack in the longitudinal direction along the respective supply air path.

The tapered spacer has the advantage that less space is required for the membrane stack as a whole, both in the vertical direction and stacking direction.

In another embodiment, it may be provided that the respective spacer at the exhaust air inlet and/or at the exhaust air outlet is configured to be permeable and/or flowable in the transverse direction for the exhaust air flow. This allows the exhaust air flow at the exhaust air inlet to flow particularly easily into the respective exhaust air path through the spacer and/or to flow out of the respective exhaust air path particularly easily at the exhaust air outlet through the spacer.

Preferably, the permeability or flowability of the spacer at the exhaust air inlet or at the exhaust air outlet can be produced by the fact that, according to an advantageous embodiment, the respective spacer at the exhaust air inlet can have several inlet channels arranged next to each other in the longitudinal direction, which connect the exhaust air inlet to the respective exhaust air path. In addition or alternatively, the respective spacer at the exhaust air outlet may have several outlet channels arranged next to each other in the longitudinal direction, which connect the exhaust air outlet to the respective exhaust air path. The inlet channels and outlet channels greatly simplify the supply of exhaust air to the respective exhaust air path and the removal of exhaust air from the respective exhaust air path located between the membranes adjacent to the spacer. Furthermore, the inlet channels and outlet channels formed on the spacer ensure a predefined flow cross-section at the inlet and outlet of the respective exhaust air path.

According to another advantageous embodiment, the respective spacer in the respective exhaust air path may have several ribs which extend in the transverse direction along the respective exhaust air path and are spaced apart from one another in the longitudinal direction. The ribs are elongated and, in particular, straight in configuration, so that they have a longitudinal direction that is essentially parallel to the transverse direction. The ribs create the spacing between the membranes resting on the spacer. For this purpose, the ribs are in contact with the membranes. Furthermore, the ribs in the exhaust air path are easily bypassed by the exhaust air flow and offer only minimal resistance to air flow. In addition, the closely spaced ribs provide good membrane support.

In this context, “configuration” corresponds to “design” and/or “setup,” so that the phrase “configured so that” is synonymous with the phrase “designed so that” and/or “set up so that”.

According to an advantageous embodiment, the ribs may comprise several rib sections arranged one after the other in the transverse direction and offset from one another in the longitudinal direction. In other words, the respective rib does not extend continuously in the transverse direction through the entire exhaust air path, but is divided into several successive rib sections that are offset from each other in the longitudinal direction. This ensures a certain degree of mixing and homogenization of the exhaust air flow in the longitudinal direction. The fact that the ribs do not extend continuously in the transverse direction also improves water transfer through the membranes of the membrane stack, as the membranes are correspondingly less covered by the ribs.

In another embodiment, the respective spacer in the respective exhaust air path may be provided with a plate which extends in the longitudinal direction and in the transverse direction through the respective exhaust air path and from which the ribs project on both sides in the stacking direction. This allows the exhaust air flow passing through the respective exhaust air path to be divided into two partial flows, such that one partial flow flows on one side of the plate and between the plate and one membrane, while the other partial flow flows on the other side of the plate and between the plate and the other membrane. This improves humidity transfer to the two supply air paths between which the exhaust air path assigned to the respective spacer is located.

In another embodiment, the respective spacer in the stacking direction can be configured to be impermeable to air. This measure ensures that both membranes, which delimit the respective exhaust air path, are evenly permeated by exhaust air, which promotes humidity transfer. The spacer can be configured, in particular with the aid of the aforementioned plate, so that it is impermeable to air in the stacking direction. In particular, the plate of the spacer can extend in the transverse direction and in the longitudinal direction over the entire exhaust air path associated with the spacer.

Alternatively, a configuration is also conceivable in which the respective spacer in the stacking direction is designed to be permeable to air. The ribs can then be configured continuously in the transverse direction, and ribs that are adjacent in the longitudinal direction can optionally be connected to each other with webs to stabilize the spacer.

In an advantageous embodiment, it may be provided that the respective spacer has an inlet region adjacent to the exhaust air inlet, in which the two membranes adjacent to the respective spacer are fastened to the respective spacer. The inlet channels mentioned above may be located in this inlet region. In addition or as an alternative, the respective spacer may have an outlet region adjacent to the exhaust air outlet, in which the two membranes adjacent to the respective spacer are fastened to the respective spacer. The outlet channels mentioned above may be located in this outlet region. This results in a simplified structure for the membrane stack. For example, the spacers can be fitted with the corresponding membranes to form an intermediate product, which can then be stacked in the stacking direction to form the membrane stack.

It is practical for the two membranes adjacent to the respective spacer to be fastened to the respective spacer in a material-locking manner, in particular by means of an adhesive or by welding. This makes it particularly easy to fasten the membranes to the respective spacer, even in series production. It is noteworthy that the membranes are fastened to the spacer with the side facing the respective exhaust air path, so that excess pressure in the adjacent supply air path presses the membranes against the spacer, which means that the fastening is only subjected to pressure and shear stress in relation to the stacking direction, and not to tensile stress. This is particularly advantageous for membranes that are sensitive to bending.

According to another embodiment, the respective spacer in the inlet region and/or in the outlet region for the two adjacent membranes may each have a step in which the respective membrane is recessed and fastened to the spacer. Due to the recessed or sunken arrangement of the membranes on the spacer, the spacers equipped with membranes, i.e., the intermediate product mentioned above, can be easily stacked on top of each other in the stacking direction to form the membrane stack.

A configuration in which the spacers following one another in the stacking direction are adjacent to one another and/or fastened to one another in the inlet regions and/or in the outlet regions outside the membranes is particularly useful. This simplifies the assembly of the membrane stack. In particular, the fastening of adjacent spacers to each other is improved. Another advantage is that if the spacers warp or deform during operation of the air humidifier as a result of stress, the (sensitive) membranes remain largely unaffected.

It is advantageous if the spacers, which are arranged one behind the other in the stacking direction, are fastened to one another in the inlet regions and/or in the outlet regions outside the membranes in a material-locking manner, in particular by means of an adhesive. This fastening technology is particularly easy to implement in series production. For improved quality of the adhesive bond, the spacers in the inlet region and/or in the outlet region may preferably have several spacer elements on only one side with respect to the stacking direction, which bear against the adhesive layer at the inlet region or outlet region of the adjacent spacer. This ensures that the adhesive layer is of uniform thickness.

A configuration in which the respective spacer at the supply air inlet has a rounded inlet edge or inflow edge configured to feed the supply air flow to the two supply air paths located on both sides of the respective spacer with respect to the stacking direction is particularly advantageous. In addition or alternatively, the respective spacer at the supply air outlet may have a rounded outlet edge or outflow edge configured to divert the supply air flow from the two supply air paths located on both sides of the respective spacer with respect to the stacking direction. In this way, the flow of supply air at the inlet and outlet of the two supply air paths, which are located on both sides of the exhaust air path assigned to the respective spacer, can be configured so that as little turbulence as possible is formed and, as a result, the lowest possible flow resistance is created.

In another embodiment, the respective spacer at the supply air inlet may be provided with at least one support element so that spacers adjacent to each other in the stacking direction at the supply air inlet are supported against each other in the stacking direction via the support elements. In addition or alternatively, the respective spacer at the supply air outlet may have at least one support element so that spacers adjacent to each other in the stacking direction at the supply air outlet are supported against each other in the stacking direction via the support elements. Supporting the stacked spacers at the supply air inlet and/or supply air outlet significantly stabilizes the membrane stack.

The at least one support element of the respective spacer at the supply air inlet and/or at the supply air outlet also offers the advantage that no further spacers are required in the respective supply air path, so that a structurally simple membrane stack can be achieved.

Furthermore, the at least one support element may be located on the supply air inlet and/or on the supply air outlet outside the membranes arranged on the respective spacer. This has the advantage that no recesses need to be provided for the membranes to be attached to the spacer, which significantly reduces the design effort.

It is advisable to configure the spacers symmetrically in the transverse direction so that they are identical at the exhaust air inlet and exhaust air outlet. In addition or alternatively, the spacers can be configured symmetrically in the longitudinal direction so that they are identical in design at the supply air inlet and supply air outlet. In addition or alternatively, the spacers can be configured symmetrically with regard to the stacking direction or vertical direction so that they are identical in this respect. These measures prevent any confusion during assembly.

An air humidifier according to the invention can be assigned to a fuel cell and used to humidify a dry supply air flow of the fuel cell by means of a humid exhaust air flow of the fuel cell. For this purpose, the air humidifier has a housing that includes a supply air inlet connection, a supply air outlet connection, an exhaust air inlet connection, and an exhaust air outlet connection. A membrane stack of the type described above is arranged in the housing. When the membrane stack is inserted into the housing, it is advisable to connect the supply air inlet connection to the supply air inlet, the supply air outlet connection to the supply air outlet, the exhaust air inlet connection to the exhaust air inlet, and the exhaust air outlet connection to the exhaust air outlet.

Other important features and advantages of the invention can be seen from the dependent claims, from the drawings and from the associated description of the figure based on the drawings.

It is understood that the above-mentioned features and those yet to be explained below can be used not only in the combination indicated in each case, but also in other combinations or on their own, without deviating from the scope of the invention. The above-mentioned components of a superordinate unit, such as a device, an apparatus, or an arrangement, which are designated separately, can form separate parts or components of this unit or be integral regions or sections of this unit, even if this is shown differently in the drawings.

Preferred exemplary embodiments of the invention are shown in the drawings by way of example and will be explained in more detail in the following description, wherein identical reference numbers refer to identical or similar or functionally identical elements.

### BRIEF DESCRIPTION OF THE DRAWINGS

The drawings, each schematically, show in

FIG. 1 shows an isometric view of an air humidifier,

FIG. 2 shows an isometric view of a membrane stack.

FIG. 3 shows an isometric view of a section of the membrane stack.

FIG. 4 shows a cross-section of the membrane stack at an exhaust air inlet,

FIG. 5 shows a longitudinal section of the membrane stack at a supply air inlet,

FIG. 6 shows an enlarged cross-section of the membrane stack at the exhaust air inlet, FIG. 7 shows an isometric partial view of a spacer,

FIG. 8 shows an isometric partial view of two adjacent spacers,

FIG. 9 shows an isometric view as in FIG. 8, but enlarged.

FIG. 10 shows an isometric view as in FIG. 9, but with only one spacer,

FIG. 11 shows another isometric view of the spacer from a different angle.

### DETAILED DESCRIPTION

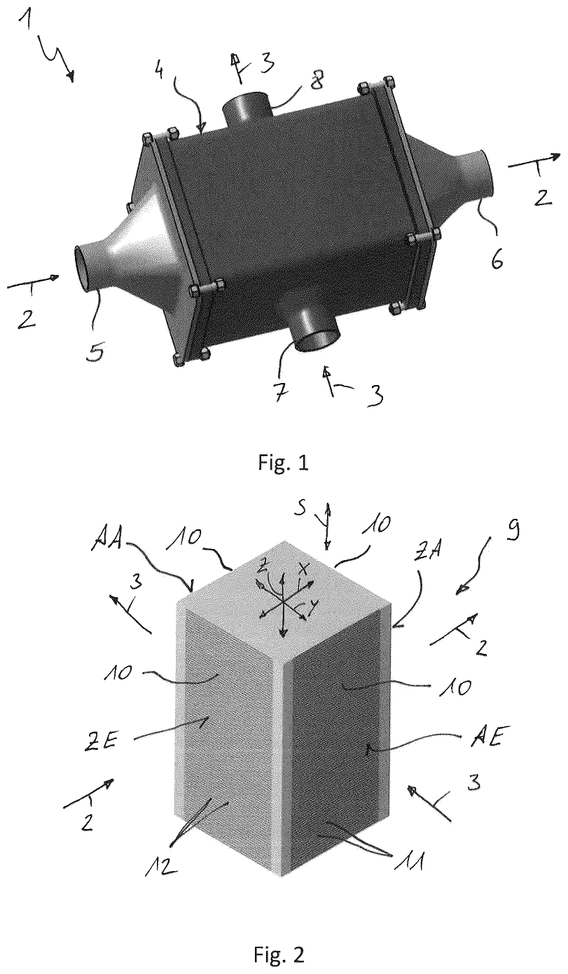

An air humidifier 1 shown in FIG. 1 is used in a fuel cell not shown here to humidify a supply air flow 2 of the fuel cell by means of an exhaust air flow 3 of the fuel cell. The supply air flow 2 is relatively dry upstream of the air humidifier 1 and relatively humid downstream of the air humidifier 1, so that the outgoing, humidified supply air flow 2 has a higher humidity than the incoming, dry supply air flow 2. The exhaust air flow 3 is relatively humid upstream of the air humidifier 1 and relatively dry downstream of the air humidifier 1, so that the outgoing, dehumidified exhaust air flow 3 has a lower humidity than the incoming, humid exhaust air flow 3. The air humidifier 1 has a housing 4 that has a supply air inlet connection 5, a supply air outlet connection 6, an exhaust air inlet connection 7, and an exhaust air outlet connection 8. A membrane stack 9 shown in FIG. 2 is arranged in housing 4 and has a cuboid configuration. The membrane stack 9 has a stacking direction S and four stacking sides 10 transverse to the stacking direction S. Furthermore, the membrane stack 9 has a vertical direction Z parallel to the stacking direction S, a longitudinal direction X perpendicular to the vertical direction Z, and a transverse direction Y perpendicular to the vertical direction Z and perpendicular to the longitudinal direction X. The four stacking sides 10 form a supply inlet ZE and a supply outlet ZA, which are facing away from each other in the longitudinal direction X, as well as an exhaust air inlet AE and an exhaust air outlet AA, which are facing away from each other in the transverse direction Y. When installed, i.e., when the membrane stack 9 is inserted into the housing 4, the supply air inlet connection 5 in the housing 4 is connected to the supply air inlet ZE, the supply air outlet connection 6 in the housing 4 is connected to the supply air outlet ZA, the exhaust air inlet connection 7 in housing 4 is connected to the exhaust air inlet AE, and the exhaust air outlet connection 8 in housing 4 is connected to the exhaust air outlet AA.

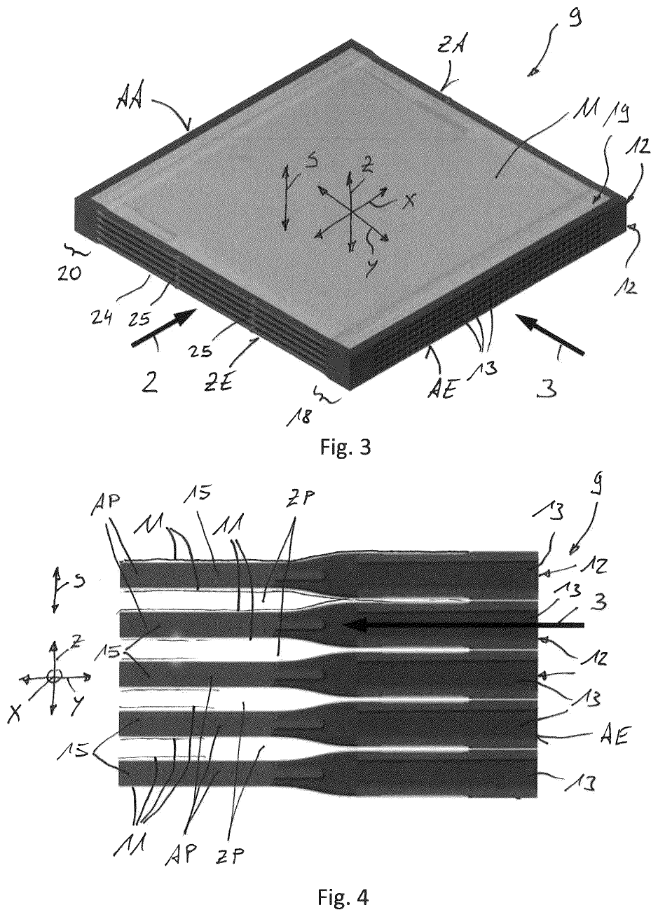

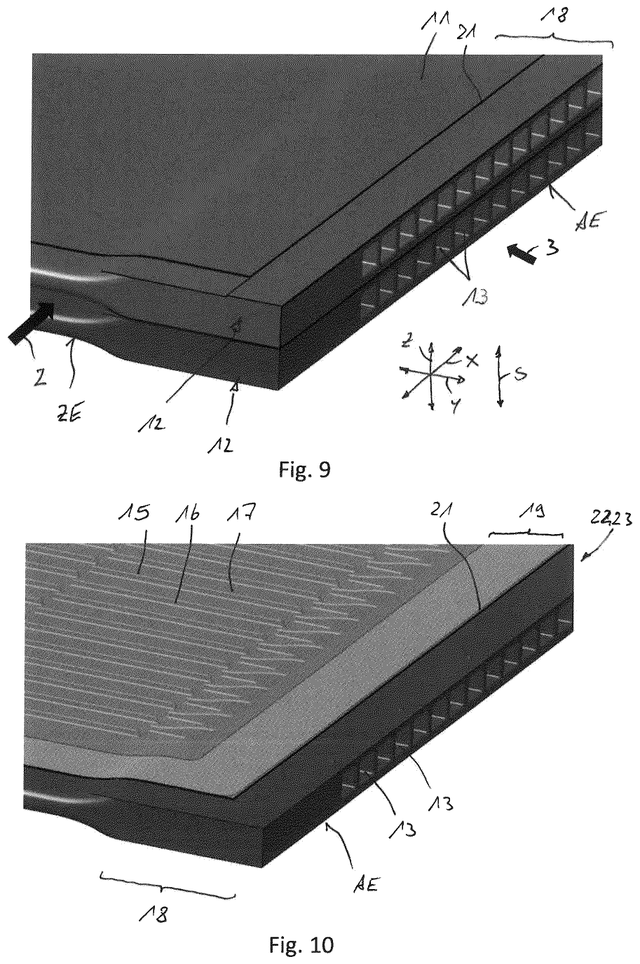

The membrane stack 9 also has several membranes 11, which can be seen in FIGS. 3 through 11. The membranes 11 are made of a material that is permeable to humidity, in particular to liquid and/or vaporous water, and essentially impermeable to air. The membranes 11 follow one another in the stacking direction S in such a way that the membranes 11 within the membrane stack 9 each separate a supply air path ZP from an exhaust air path AP. The supply air paths ZP can be seen in FIGS. 4 through 6 and connect the supply air inlet ZE with the supply air outlet ZA. The exhaust air paths AP are also shown in FIGS. 4 through 6 and connect the exhaust air inlet AE with the exhaust air outlet AA.

As shown in FIGS. 3 through 11, the membrane stack 9 has several spacers 12, which are arranged in the stacking direction S between two immediately successive membranes 11 in one of the exhaust air paths AP. The spacers 12 are arranged between two adjacent membranes 11 in such a way that the two membranes 11 rest against the respective spacer 12 and are spaced apart from each other in the stacking direction S in the exhaust air path AP in which the spacer 12 is arranged. In other words, spacer 12 ensures that the membranes 11 adjacent to each other in the stacking direction S, which delimit an exhaust air path AP between them, do not touch each other in the exhaust air path AP.

According to FIGS. 4, 6, 7, and 8, the respective spacer 12 between the exhaust air inlet AE and the exhaust air outlet AA has a taper in the vertical direction Z, in particular a reduction in thickness.

The respective tapering of two spacers 12 directly following one another in stacking direction S forms the respective supply air path ZP and/or delimits it.

In other words, the respective rejuvenation of two spacers 12 directly following one another in stacking direction S allows the membrane stack 9 to be flowed through in longitudinal direction X along the respective supply air path ZP.

The tapered spacer 12 has the advantage that less space is required for the membrane stack 9 as a whole in the vertical direction Z or in the stacking direction S.

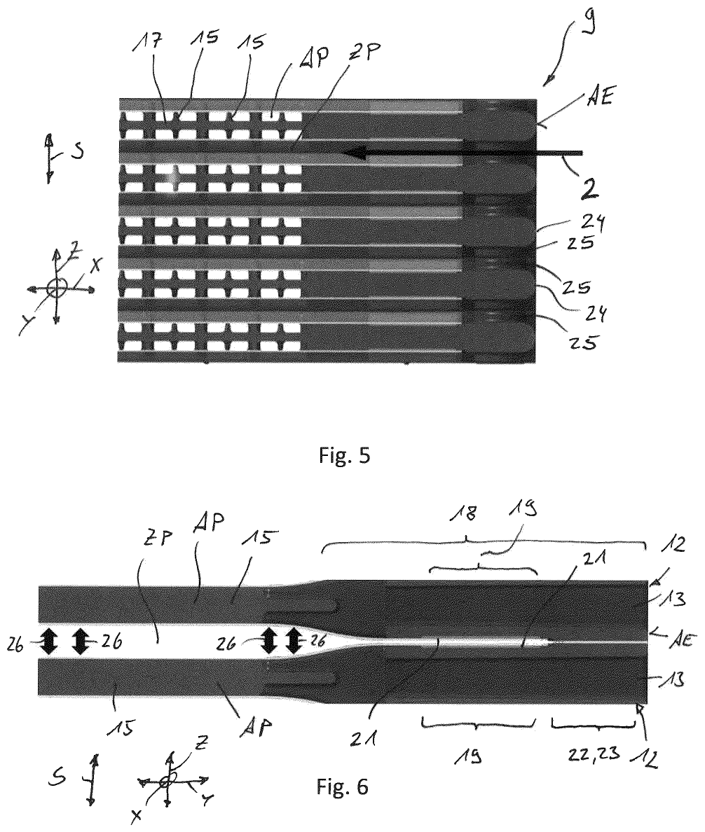

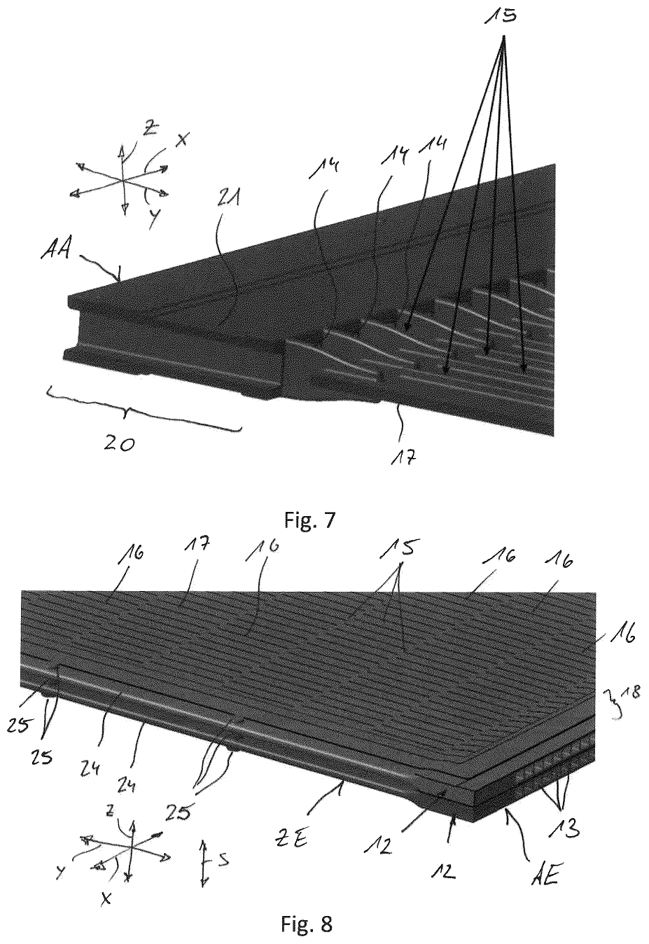

The respective spacer 12 is configured at the exhaust air inlet AE and at the exhaust air outlet AA in the transverse direction Y so that it is permeable and/or flowable for the exhaust air flow 3. In the examples shown here, this is achieved by the respective spacer 12 having, as shown in FIGS. 3, 4, 6, 8 through 10, several inlet channels 13 at the exhaust air inlet AE, which are arranged next to each other in the longitudinal direction X and connect the exhaust air inlet AE to the respective exhaust air path AP. Similarly, the respective spacer 12 at the exhaust air outlet AA can have several outlet channels 14 arranged next to each other in the longitudinal direction X, which connect the exhaust air outlet AA to the respective exhaust air path AP, as shown in FIG. 7. According to FIGS. 5 through 10, the respective spacer 12 in the respective exhaust air path AP may have several ribs 15, which are configured in a straight line and elongated and which extend in the transverse direction Y along the respective exhaust air path AP and are spaced apart from one another in the longitudinal direction X. The membranes 11 assigned to the respective spacer 12 lie along the respective exhaust air path AP in the stacking direction S against the ribs 15. As can be seen in particular from FIG. 8, the ribs 15 can each have several rib sections 16 that follow one another in the transverse direction Y and are offset from one another in the longitudinal direction X. In other words, the respective rib 15 does not extend continuously in the transverse direction Y through the entire exhaust air path AP, but is divided into several successive rib sections 16 which are offset from one another in the longitudinal direction X. Since the ribs do not extend continuously in the transverse direction Y, water transfer through the membranes 11 of the membrane stack 9 can be improved, as the membranes 11 are correspondingly less covered by the ribs 15.

The spacer 12 in the respective exhaust air path AP has a plate 17, which can be seen in FIGS. 4 through 8. The plate 17 extends in the longitudinal direction X and in the transverse direction Y through the respective exhaust air path AP. From this plate 17, ribs 15 protrude on both sides in the stacking direction S. The respective spacer 12 can be configured to be impermeable to air in the stacking direction S. This can be achieved in particular with the aid of plate 17, which is dimensioned for this purpose so that it extends in the longitudinal direction X and in the transverse direction Y over the entire exhaust air path AP and over the entire membrane stack 9, respectively.

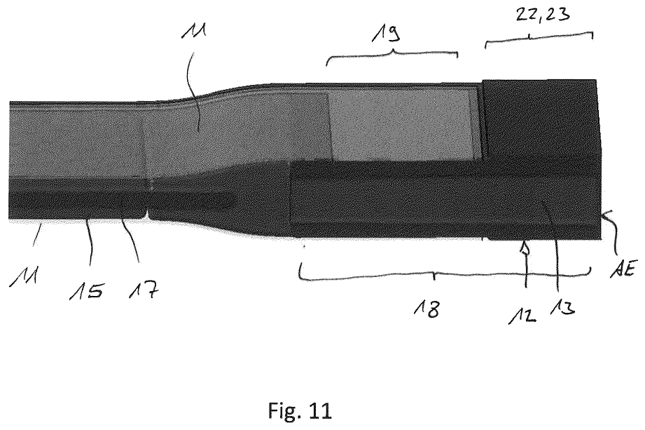

According to FIGS. 4 and 6, the respective spacer 12 may have an inlet region 18 adjacent to the exhaust air inlet AE, in which, in particular, the aforementioned inlet channels 13 extend. In this inlet region 18, the two membranes 11 adjacent to the respective spacer 12 can be fastened to the respective spacer 12. A material-locking fastening is preferred, in particular a fastening by means of an adhesive or by welding. FIG. 6 shows an adhesive region 19 with curved brackets for the two membranes 11, which are located on two adjacent spacers 12, face each other and form one of the supply air paths ZP between them. In a similar manner, the membranes 11 can also be fastened to the respective spacer 12, in particular so that they are connected in a material-locking manner, preferably bonded, at an outlet region 20 adjacent to the exhaust air outlet AA, as shown in FIG. 7. The outlet channels 14 may be located in the outlet region 20. Furthermore, the respective spacer 12 in the inlet region 18 according to FIGS. 6 and 11 and in the outlet region 20 according to FIG. 7 may have a step 21 for each of the two adjacent membranes 11, in which the respective membrane 11 is recessed and fastened to the spacer 12. In particular, bonding between the membrane 11 and the spacer 12 takes place within this step 21.

According to FIGS. 4 and 6, the spacers 12, which follow one another in the stacking direction S, can rest against one another and/or be fastened to one another in the inlet regions 18 outside the membranes 11. This has the advantage that if the spacers 12 warp or deform during operation of the air humidifier 1 as a result of loads occurring, the (sensitive) membranes 11 remain at least largely unaffected by this.

In FIG. 6, an installation region 22 and/or a fastening region 23, in which the adjacent spacers 12 are in contact with each other and/or fastened to each other, is indicated by a curved bracket. The two adjacent spacers 12 can preferably be fastened together in a material-locking manner, in particular by means of an adhesive.

According to FIGS. 5 and 8 through 10, the respective spacer 12 at the supply air inlet ZE may have a rounded inlet edge 24 which is configured so as to deflect the supply air flow 2 in a flow-optimized manner or and with low flow resistance to the two supply air paths ZP, which are located on both sides of the respective spacer 12 with respect to the stacking direction S. In a similar manner, the respective spacer 12 at the supply air inlet ZA may have a rounded outlet edge not shown here. The outlet edge is configured for the flow-optimized discharge of the supply air flow 2 from the two supply air paths ZP, which are located on both sides of the respective spacer 12 with respect to the stacking direction S. In particular, the inlet edge 24 and the outlet edge may be configured identically.

According to FIGS. 3, 5, and 8, the respective spacer 12 at the supply air inlet ZE may have at least one support element 25. The support elements 25 are configured such that adjacent spacers 12 in the stacking direction S can be supported against each other in the stacking direction S at the supply air inlet ZE via these support elements 25. In the preferred embodiment shown here, the support elements 25 of one spacer 12 rest against the support elements 25 of the other spacer 12. In principle, a design is also possible in which the support elements 25 of one spacer 12 are supported directly on the other spacer 12, and vice versa. It may also be useful to implement a similar configuration at the supply air outlet ZA, so that the respective spacer 12 at the supply air outlet ZA has at least one support element not shown here, wherein the support elements are also configured here such that spacers 12 adjacent to one another in the stacking direction S at the supply air outlet ZA are supported against one another in the stacking direction S via the support elements. In principle, the support elements on the supply air outlet ZA can be configured identically to the support elements 25 on the supply air inlet ZE.

The fact that at least one support element 25 of the respective spacer 12 at the supply air inlet ZE and/or the at least one support element at the supply air outlet ZA offers the advantage that no spacers are required in the respective supply air path ZP, so that a structurally simple diaphragm stack 9 can be provided.

Furthermore, according to FIGS. 3 and 5, the at least one support element 25 at the supply air inlet ZE and the at least one support element at the supply air outlet ZA can be located outside the membranes 11 arranged on the respective spacers 12.

This has the advantage that no recesses need to be provided for the membranes 11 for attachment to the spacer 12, so that the design effort can be significantly reduced.

According to FIG. 6, pressure forces 26 occur in the supply air paths ZP during operation of the air humidifier 1, which are indicated in FIG. 6 by double arrows running parallel to the stacking direction S. These pressure forces 26 occur because during operation of the air humidifier 1, there is usually greater pressure in the supply air flow 2 than in the exhaust air flow 3. Accordingly, there is positive pressure in the supply air paths ZP relative to the adjacent exhaust air paths AP. The resulting pressure forces 26 drive the two membranes 11, which delimit the respective supply air path ZP in the stacking direction S, in the stacking direction S against the respective adjacent exhaust air path AP. However, the height of the respective exhaust air path AP measured in the vertical direction Z is determined by the spacer 12 extending therein. As a result, the membranes 11 subjected to overpressure in the respective supply air path ZP can rest against the respective spacer 12 in the adjacent exhaust air path AP. The excess pressure in the respective supply air path ZP also causes the fastening regions 19 to be subjected to pressure in relation to the stacking direction S, which is not critical for the fastening between the membranes 11 and the spacers 12.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the phrase “at least one of” followed by successive elements separate by the word “and” (e.g., “at least one of A and B”) is to be interpreted the same as “and/or” and as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

All matter contained in the above description or shown in the accompanying drawings shall be interpreted as illustrative only and not limiting. Changes in detail or structure may be made without departing from the present disclosure.

1. A membrane stack for an air humidifier of a fuel cell for humidifying a dry supply air flow of the fuel cell via a humid exhaust air flow of the fuel cell, comprising:
a plurality of membranes that are permeable to humidity and impermeable to air, the plurality of membranes arranged one above another in a stacking direction such that at least a subset of the plurality of membranes each separate a respective supply air path of a plurality of supply air paths, which each connect a supply air inlet to a supply air outlet, from a respective exhaust air path of a plurality of exhaust air paths, which each connect an exhaust air inlet to an exhaust air outlet;
a plurality of spacers each arranged in the stacking direction between two directly adjacent membranes of the plurality of membranes and in one of the plurality of exhaust air paths;
wherein the membrane stack is configured in a cuboid shape and has four stacking sides transverse to the stacking direction;
wherein the membrane stack has a vertical direction extending parallel to the stacking direction, a longitudinal direction extending perpendicular to the vertical direction, and a transverse direction extending perpendicular to the vertical direction and perpendicular to the longitudinal direction; and
wherein the four stack sides form the supply air inlet, the supply air outlet, the exhaust air inlet, and the exhaust air outlet, the supply air inlet and the supply air outlet facing away from each other and disposed spaced apart from one another in the longitudinal direction, the exhaust air inlet and the exhaust air outlet facing away from each other and disposed spaced apart from one another in the transverse direction.

2. The membrane stack according to claim 1, wherein:
each of the plurality of spacers has, between the exhaust air inlet and the exhaust air outlet, a taper in the vertical direction; and
the respective tapering of two spacers of the plurality of spacers immediately following one another in the stacking direction delimits the respective supply air path.

3. The membrane stack according to claim 1, wherein at least one spacer of the plurality of spacers, at the exhaust air inlet and/or at the exhaust air outlet, is, in the transverse direction, permeable and/or passable for the exhaust air flow.

4. The membrane stack according to claim 1, wherein:
at least one spacer of the plurality of spacers, at the exhaust air inlet, includes a plurality of inlet channels arranged next to each other in the longitudinal direction, which connect the exhaust air inlet to the respective exhaust air path; and/or
at least one spacer of the plurality of spacers, at the exhaust air outlet, includes a plurality of outlet channels arranged next to each other in the longitudinal direction, which connect the exhaust air outlet to the respective exhaust air path.

5. The membrane stack according to claim 1, wherein at least one spacer of the plurality of spacers includes, in the respective exhaust air path, a plurality of ribs extending in the transverse direction along the respective exhaust air path and disposed spaced apart from one another in the longitudinal direction.

6. The membrane stack according to claim 5, wherein the plurality of ribs each include a plurality of rib sections that follow each other in the transverse direction and that are arranged offset from each other in the longitudinal direction.

7. The membrane stack according to claim 5, wherein at least one spacer of the plurality of spacers has, in the respective exhaust air path, a plate extending in the longitudinal direction and in the transverse direction through the respective exhaust air path and from which the plurality of ribs project on both sides in the stacking direction.

8. The membrane stack according to claim 1, wherein at least one spacer of the plurality of spacers is impermeable to air in the stacking direction.

9. The membrane stack according to claim 1, wherein at least one spacer of the plurality of spacers has:
an inlet region disposed adjacent to the exhaust air inlet and in which the two membranes adjacent to the respective spacer are connected to the respective spacer; and/or
an outlet region disposed adjacent to the exhaust air outlet and in which the two adjacent membranes bearing against the respective spacer are connected to the respective spacer.

10. The membrane stack according to claim 9, wherein the at least one spacer includes:
in the inlet region, a first step in which a respective membrane of the two adjacent members is recessed and connected to the respective spacer; and/or
in the outlet region, a second step in which a respective membrane of the two adjacent membranes is recessed and connected to the respective spacer.

11. The membrane stack according to claim 9, wherein at least some of the plurality of spacers following one another in the stacking direction in the inlet region and/or in the outlet region outside the plurality of membranes are adjacent to one another and/or are fastened to one another.

12. The membrane stack according to claim 11, wherein the at least some spacers of the plurality of spacers following one another in the stacking direction are fastened to one another in the respective inlet region and/or in the respective outlet region outside the plurality of membranes in a material-locking manner.

13. The membrane stack according to claim 1, wherein at least one spacer of the plurality of spacers has:
at the supply air inlet, has a rounded inlet edge configured to feed the supply air flow to two supply air paths of the plurality of supply air paths, which are located on both sides of the respective spacer with respect to the stacking direction; and/or
at the supply air outlet, a rounded outlet edge configured to divert the supply air flow from the two supply air paths.

14. The membrane stack according to claim 1, wherein at least one spacer of the plurality of spacers includes:
at the supply air inlet, at least one support element such that that adjacent spacers of the plurality of spacers, which are adjacent to each other in the stacking direction at the supply air inlet, are supported against each other in the stacking direction via the at least one support element; and/or
at the supply air outlet, at least one support element such that adjacent spacers of the plurality of spacers, where are adjacent to each other in the stacking direction at the supply air outlet, are supported against each other in the stacking direction via the at least one support element.

15. An air humidifier for a fuel cell for humidifying a dry supply air flow of the fuel cell via a humid exhaust air flow of the fuel cell, comprising:
a housing including a supply air inlet connection, a supply air outlet connection, an exhaust air inlet connection, and an exhaust air outlet connection; and
the membrane stack according to claim 1, the membrane stack arranged in the housing.

16. A membrane stack for an air humidifier of a fuel cell for humidifying a dry supply air flow of the fuel cell via a humid exhaust air flow of the fuel cell, comprising:
a plurality of membranes that are permeable to humidity and impermeable to air, the plurality of membranes arranged one above another in a stacking direction and defining a plurality of supply air paths and a plurality of exhaust air paths arranged in an alternating manner in the stacking direction; and
a plurality of spacers arranged in the plurality of exhaust air paths, each spacer of the plurality of spacers arranged in a respective exhaust air path of the plurality of exhaust air paths and contacting a respective pair of adjacent membranes of the plurality of membranes that define the respective exhaust air path;
wherein the plurality of supply air paths extend transversely to the stacking direction from a supply air inlet to a supply air outlet, which are disposed on opposite sides of the plurality of membranes; and
wherein the plurality of exhaust air paths extend transversely to the stacking direction and to the plurality of supply air paths from an exhaust air inlet to an exhaust air outlet, which are disposed on opposite sides of the plurality of membranes.

17. The membrane stack according to claim 16, wherein:
each of the plurality of spacers has, disposed between the exhaust air inlet and the exhaust air outlet, a tapered region with a reduced dimension in the stacking direction;
the plurality of spacers including a plurality of spacer pairs, each of the plurality of spacer pairs including a first spacer, a second spacer disposed directly adjacent to the first spacer in the stacking direction, and a gap formed between the tapered region of the first spacer and the tapered region of the second spacer; and
each of the plurality of supply air paths is disposed within and extends through the gap of a respective spacer pair of the plurality of spacers.

18. The membrane stack according to claim 17, wherein:
each of the plurality of spacers includes i) an inlet region disposed adjacent to the exhaust air inlet and ii) an outlet region disposed adjacent to the exhaust air outlet;
the inlet region and the outlet region each include a first recessed area and a second recessed area disposed opposite one another in the stacking direction;
the first recessed area of the inlet region and the first recessed area of the outlet region receive and accommodate a respective first membrane of the plurality of membranes; and
the second recessed area of the inlet region and the second recessed area of the outlet region receive and accommodate a respective second membrane of the plurality of membranes.

19. The membrane stack according to claim 18, wherein:
the inlet region and the outlet region each further include a first contact area and a second contact area disposed opposite one another in the stacking direction; and
in each of the plurality of spacer pairs, i) the first contact area of the inlet region of the first spacer and the second contact area of the inlet region of the second spacer are arranged on one another and ii) the first contact area of the outlet region of the first spacer and the second contact area of the outlet region of the second spacer are arranged on one another.

20. The membrane stack according to claim 19, wherein:
the first contact area and the second contact area of the inlet region are disposed offset from the respective first membrane and the respective second membrane toward the exhaust air inlet; and
the first contact area and the second contact area of the outlet region are disposed offset from the respective first membrane and the respective second membrane toward the exhaust air outlet.
